(19) United States
(12) Patent Application Publication
(10) Pub. No.: US 2024/0123460 A1
(43) Pub. Date: Apr. 18, 2024

(54) METHODS, SYSTEMS AND COMPUTER PROGRAM PRODUCTS FOR PRODUCTION AND APPLICATION OF SPRAY FOAM USING OPTICAL AND INFRARED IMAGING

(71) Applicant: Covestro LLC, Pittsburgh, PA (US)

(72) Inventors: Devin W. Ulam, Pittsburgh, PA (US); David D. Steppan, Gibsonia, PA (US); Scott M. Cloherty, Canonsburg, PA (US); Steven G. Owens, Sewickley, PA (US); Eric C. Giles, Pittsburgh, PA (US)

(21) Appl. No.: 17/766,559

(22) PCT Filed: Oct. 6, 2020
(86) PCT No.: PCT/US2020/054359

§ 371 Date: Apr. 5, 2022

Related U.S. Application Data
(60) Provisional application No. 62/914,009, filed on Oct. 11, 2019.

(51) Int. Cl. B05B 12/08; B05D 1/02; G06T 1/00; G06T 7/00

(52) U.S. Cl. CPC B05B 12/084; B05D 1/02; G06T 1/0014; G06T 7/0006; G06T 2200/24; G06T 2207/30108

(57) ABSTRACT

Disclosed are methods, systems and computer program products for producing and applying a spray foam producing mixture onto a surface, and imaging a spray cone, or the applied surface, using an infrared or an optical imaging device to capture an image, and then determining, based on the captured image, if a defect that requires correction exists in the spray cone or in the applied surface; and optionally, in response to determining that a defect requiring correction exists, modifying a process parameter in producing or applying spray foam.

### FIELD

The present invention is directed to, among other things, methods, systems and computer program products for the production and application of spray foam using optical and infrared imaging.

### BACKGROUND

Insulation plays an important role in the energy efficiency and environmental impact of building envelopes. There are areas where insulation foam is typically sprayed, rather than foam boards installed, such as in retrofitting older buildings with insulation, or in irregular shaped rooms, or upon the inside surfaces of roofs. Spray foam is typically produced on-site, just before it is applied. Several components are mixed together just before the mixture is sprayed onto a surface. In producing and applying spray foam, it is important to maintain good quality control, so the foam will function as expected, and is applied to all of the area that require it. In addition, like many processes, it is important to minimize waste and downtime as producers strive to utilize their assets and raw materials to a more efficient manner.

The raw materials that are used in creating spray foam are fluids that are designed to react and harden quickly once they are applied onto a surface. If the mixture is not produced correctly, the foam may be created with irregular foam density, or have voids inside the foam, which may act to decrease the insulating quality of the foam. While quality control process may identify some defects, it may not be until a later date, or require significant extra time to detect the areas which may have to be resprayed. Meanwhile, time may be wasted while the process is shut down to fix whatever caused the quality problem.

It would be desirable to improve the methods of producing and applying spray foam, to reduce the amount of waste or substandard foam product, to reduce the amount of downtime in fixing the production and application processes for spray foam, and to improve the utilization of raw materials and the assets used to create spray foam.

### SUMMARY OF THE INVENTION

In one embodiment, a method, system or a computer program product for producing and applying spray foam is disclosed, comprising: preparing a foam producing mixture comprising components: an organic isocyanate, a polymeric polyol and a blowing agent; spraying the foam producing mixture from a spray application device onto a surface, forming a cone in the space between the spray application device and the surface, and applying the foam producing mixture onto the surface; imaging at least one of the cone, or the applied surface, using an infrared or an optical imaging device, to capture an image of the cone or the applied surface; receiving a first signal comprising the captured image from the imaging device to a computing device; determining, based on the captured image, if a defect that requires correction exists in the cone or in the applied surface; and optionally, in response to determining that a defect requiring correction exists, modifying a process parameter in producing or applying spray foam. The infrared or optical imaging device may be an infrared camera.

In another embodiment, the defect is selected from the group consisting of voids are being produced in the foam, the foam has insufficient density, the foam has insufficient thickness, the cone or spray pattern is not the expected shape or pattern, the surface to be applied already has sufficient foam covering and the spray temperature is insufficient.

In a different embodiment, the process parameter is selected from the group consisting of altering the relative flow of a component of the mixture, altering the relative pressure of a component of the mixture, or include a different component into the mixture, increasing or decreasing the heat applied to the mixture, adjusting a setting on the spray application device, stopping the spray foam application, or designating areas to spray foam or to re-spray foam.

In yet another embodiment, the disclosed further comprises the steps of: determining the applied spray foam does not meet quality standards, based on the captured image of the apply foam; determining that adding additional spray foam will satisfy quality standards; and applying additional spray foam to meet quality standards.

In still another embodiment, the disclosed further comprises the step of projecting a visual indication of where additional spray foam is needed to be applied to meet quality standards, or when too much foam has been applied. In a different embodiment, the projecting a visual indication is by one of a laser, a light projector, a heads up display, or by visual or augmented reality.

In a new embodiment, the disclosed further comprises the step of providing auditory indication of where additional spray foam is needed to be applied to meet quality standards, or when too much foam has been applied. In yet another, the providing auditory indication is by one of a speaker, a headset, or an earbud.

In an embodiment different from the others, the disclosed further comprises the steps of: displaying on a user interface at least one of a process parameter and a visual representation of the captured image; receiving on the user interface an input to change at least one process parameter; and altering the at least one process parameter in response to the input from the user interface.

In another, in response to determining that a defect requiring correction has appeared, modifying a process parameter in producing or applying the spray foam, comprises: receiving, with at least one processor, at least one of: (a) data associated with a previously-stored solution to correcting the defect that has appeared in the cone or in the applied surface; or (b) data from a predictive model used to generate a solution to correcting the defect that has appeared in the cone or in the applied surface; and altering at least one process parameter in response to the data received by the at least one processor.

In a new embodiment, the disclosed further comprises the steps of: receiving a second signal comprising a captured image from the imaging device to a computing device, after the process parameter has been modified; and storing data associated with the first and second signals, and the modification of the process parameter in producing or applying spray foam, to the computing device.

In a different new embodiment, the disclosed further comprises the step of placing on a moveable robot, at least one of a spray application device, an IR camera, an optical camera, and a projection device.

In another, the disclosed further comprises the steps of: placing a projection device on a moveable robot; and projecting, from the projection device, a visual indication of where additional spray foam is needed to be applied to meet quality standards.

In still another embodiment, the disclosed further comprises the steps of: placing a spray application device on a moveable robot; and transmitting a signal to the robot or spray application device to modify a process parameter in producing or applying spray foam.

### BRIEF DESCRIPTION OF THE DRAWINGS

FIG. 1 is a schematic view for a process analyzer and controller; and

FIG. 2 is a step diagram for a method for analyzing and controlling a process to mix and apply spray foam, after a problem has been detected.

### DETAILED DESCRIPTION

Various embodiments are described and illustrated in this specification to provide an overall understanding of the structure, function, properties, and use of the disclosed inventions. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer (e.g., laptop computer or tablet computer), a wearable device (e.g., watches, glasses, lenses), a personal digital assistant (PDA), and/or other like devices. In other non-limiting embodiments, the computing device may be a desktop computer or other non-mobile computer. Furthermore, the term “computer” may refer to any computing device that includes the necessary components to receive, process, and output data, and normally includes a processor, a memory, an input device, and a network interface. While a computer may further include a display, a display is not required for all embodiments. An “interface” refers to a generated display, such as one or more graphical user interfaces (GUIs) with which a user may interact, either directly or indirectly (e.g., through a keyboard, mouse, etc.). Further, one or more computers, e.g., servers, or other computerized devices, directly or indirectly communicating in the network environment may constitute a “system”.

The raw materials used in producing spray foam are fluids: liquids or gases that are sprayed into atmospheric pressure and temperature conditions, where the materials react with each other to produce foam. Such foam producing mixtures are typically prepared such that components of the mixture typically are mixed together just before it is sprayed and applied on a surface, where it will harden. The foam producing mixture typically comprises an organic polyisocyanate, a polymeric polyol, and a blowing agent.

Any of the known organic polyisocyanates can be used in the practice of the present invention. Examples of suitable polyisocyanates include, without limitation, substituted or unsubstituted aromatic, aliphatic, and cycloaliphatic polyisocyanates having at least two isocyanate groups. Polyfunctional aromatic isocyanates are often used. Specific examples of suitable aromatic isocyanates include, but are not limited to, 4,4′-diphenylmethane diisocyanate (MDI), polymeric MDI (pMDI), toluene diisocyanate, allophanate-modified isocyanates, isocyanate-terminated prepolymers and carbodiimide-modified isocyanates. The organic polyisocyanate may comprise pMDI having an average NCO functionality of from 2.2 to 3.3 and a viscosity of from 25 to 2000 mPas and prepolymers thereof prepared with polyols or other oligomers or polymers such as polyether or polyester polyols that contain active hydrogen atoms. The pMDI may have a functionality of from 2.2 to 3.0 and a viscosity less than about 800 mPas at 25° C. Any mixtures of organic polyisocyanates may, of course, be used.

The organic polyisocyanate(s) is/are included in the foam producing mixture, in an amount of at least 50%, such as from 55% to 75%, or, in some cases, from 59% to 69% by weight, based on total weight of the foam producing mixture.

The polymeric polyol may be any material having at least two reactive groups capable of reacting with an isocyanate group. The polymeric polyol may be an aromatic polyester polyol and/or a polyether polyol, such as those having an average hydroxyl functionality of from 2 to 8, such as 2 to 6, or, in some cases, 2.0 to 2.5, and/or a hydroxyl number of 100 mg KOH/gm to 1000 mgKOH/gm or, in some cases, 200 mgKOH/gm to 500 mgKOH/gm. In certain embodiments, a blend of an aromatic polyester polyol and a polyester and/or polyether polyol that contains renewable content derived from incorporation of regenerable materials, such as fatty acid triglycerides, sugar, or natural glycerin, is used. The polymeric polyol(s) is/are a present in an amount of 10% to 40%, such as 20% to 40%, or, in some cases, 25% to 35% by weight, based on total weight of the foam producing mixture.

The relative amounts of organic polyisocyanate and polymeric polyol(s) used in the foam producing mixture are selected so as to provide the composition with a NCO:OH index of at least 1.8, such as at least 2.0, or, in some cases, 2.0 to 3.0.

As indicated, the mixture used in certain methods of the present invention comprises a blowing agent composition comprising one or more hydrocarbon blowing agents with an atmospheric pressure boiling point of at least 20° C. (68° F.). In certain embodiments, the blowing agent composition comprises a hydrocarbon with an atmospheric pressure boiling point of at least 20° C. (68° F.) and water. As used herein, “hydrocarbon” refers to chemical compounds composed primarily of carbon and hydrogen that may contain heteroatoms such as oxygen, nitrogen, sulfur, or other elements. In certain embodiments, halogenated blowing agents with a global warming potential (“GWP”)≥25 (100 year) and ozone depletion potential (“ODP”)>0 are not used in the practice of the present invention.

Specific examples of suitable hydrocarbons with an atmospheric pressure boiling point of at least 20° C. (68° F.) include, but are not limited to, n-pentane (atmospheric pressure boiling point of 36.1° C. (96.9° F.)), isopentane (atmospheric pressure boiling point of 27.7° C. (81.9° F.)), cyclopentane (atmospheric pressure boiling point of 49° C. (120.2° F.)), hexane (atmospheric pressure boiling point of 68° C. (154.4° F.)), 2,2-dimethylbutane (atmospheric pressure boiling point of 50° C. (122° F.)), 2-methylpentane (atmospheric pressure boiling point of 60° C. (140° F.)), 1-hexene (atmospheric pressure boiling point of 63° C. (145.4° F.)), 1-pentene (atmospheric pressure boiling point of 30° C. (86° F.)), acetone (atmospheric pressure boiling point of 56° C. (132.8° F.)), acetaldehyde (atmospheric pressure boiling point of 20.2° C. (68.4° F.)), dimethyl carbonate (atmospheric pressure boiling point of 90° C. (194° F.)), methylal (atmospheric pressure boiling point of 42.3° C. (108.1° F.)), ethyl formate (atmospheric pressure boiling point of 54.3° C. (129.7° F.)), methyl acetate (atmospheric pressure boiling point of 56.9° C. (134.4° F.)), and methyl formate (atmospheric pressure boiling point of 31.8° C. (89.2° F.)). As will of course be appreciated, mixtures of two or more of any of the foregoing or unlisted suitable hydrocarbons can be used. In certain embodiments, the hydrocarbons with an atmospheric pressure boiling point of at least 20° C. (68° F.) is n-pentane, isopentane, cyclopentane, methyl formate, and/or methylal.

In certain embodiments, the hydrocarbon with an atmospheric pressure boiling point of at least 20° C. (68° F.) is present in an amount of at least 1% by weight, such as at least 2% by weight, or, in some cases, at least 3% by weight and up to 10% by weight, such as up to 8% by weight, or, in some cases, up to 6% by weight, based on total weight of the foam producing mixture.

In addition to the hydrocarbon blowing agent, some water is often included in the blowing agent composition. As will be appreciated, water reacts with isocyanates to produce carbon dioxide gas as an auxiliary blowing agent. The amount of water included in the foam-forming composition will often range from 0.05% to 1.0% by weight, such as 0.1% to 0.8% by weight, based on total weight of the foam producing mixture.

If desired, it is also possible that the blowing agent composition comprises a hydrocarbon, such as a hydrofluoroolefin, having an atmospheric pressure boiling point of less than 20° C. (68° F.), specific examples of which include, but are not limited to, butane (atmospheric pressure boiling point of −1° C. (30.2° F.)), isobutane (atmospheric pressure boiling point of −11.7° C. (10.9° F.)), butylene (atmospheric pressure boiling point of −6.6° C. (20.1° F.)), isobutylene (atmospheric pressure boiling point of −6.9° C. (19.6° F.)), trans-1-chloro-3,3,3-trifluoropropene (atmospheric pressure boiling point of 19° C. (66.2° F.)), and dimethyl ether (atmospheric pressure boiling point of −24° C. (−11.2° F.)).

In addition, the foam producing mixture may include any of a variety of optional ingredients.

The foam producing mixture may include a flame retardant composition. Suitable flame retardants for use in the foam-forming composition include, without limitation, halogenated, such as brominated flame retardants, such as brominated polyols, and phosphonated flame retardants, such as a halogenated, such as chlorinated, phosphates.

In certain embodiments, the brominated flame retardant comprises a brominated polyether polyol of the general formula (I):

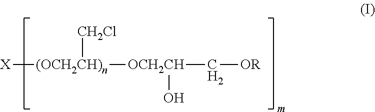

in which n is a number of 0 to 7, m is a number of 2 to 3; X is a saturated or unsaturated brominated polyol residue; and R is hydrogen or an alkyl group having 1 to 5 carbon atoms. Specific examples of suitable brominated polyether polyols are commercially available as Ixol® B-251 and Ixol® M-125 from Solvay Fluorides LLC, which are believed to be produced using the procedure described U.S. Pat. Nos. 4,020,024, 4,067,911 and 4,072,638. Other suitable brominated flame retardants include, but are not limited to, 3,4,5,6-tetrabromophthalic acid, tribromoneopentyl alcohol, 1,3-propanediol, 2,2-bis(bromomethyl), and pentabromophenyl ether, among others, including mixtures of two or more thereof. Suitable commercially available brominated flame retardants also include those available from ICL Industrial Products as the SaFRon® (6000 Series) brominated flame retardants. Mixtures of two or more of such brominated flame retardants can be used. In certain embodiments, the brominated flame retardant does not contain phosphorous.

Specific examples of suitable phosphorous compounds, such as halogenated phosphates, include, without limitation, tris-(2-chloroethyl)phosphate, tris-(2-chloroisopropyl)phosphate (TCPP), tris(1,3-dichloroisopropyl)phosphate, tris-(2,3-dibromopropyl)phosphate and tetrakis-(2-chloroethyl) ethylene diphosphate, Diethyl Bis-(2-hydroxyethyl)-aminomethylphosphonate, phosphoric acid, triethyl ester, polymer with oxirane and phosphorus oxide (P₂O₅), triethyl phosphate, including mixtures of two or more thereof. Isocyanate-reactive and/or non-reactive non-halogenated phosphorous compounds are often used.

In certain embodiments, the total amount of flame retardant in the foam producing mixture is at least 1% by weight, such as at least 2% by weight and no more than 10% by weight, such as no more than 5% by weight, based on the total weight of the foam producing mixture.

In certain embodiments, the foam producing mixture comprises a surfactant to, for example, stabilize the foaming reaction mixture until it obtains rigidity. Such surfactants often comprise a liquid or solid organosilicon compound, a polyethylene glycol ether of a long chain alcohol, a tertiary amine, an alkanolamine salt of a long chain alkyl acid sulfate ester, an alkylsulfonic ester, or an alkylarylsulfonic acid, or a mixture thereof. Such surfactants are employed in amounts sufficient to stabilize the foaming reaction mixture against collapse and the formation of large and uneven cells. Often, 0.1 to 10% by weight of the surfactant is used, based on the total weight of the foam producing mixture.

In certain embodiments, one or more catalysts are used in the foam producing mixture. Any suitable catalyst may be used including tertiary amines, such as, without limitation, triethylenediamine, N-methylmorpholine, pentamethyl diethylenetriamine, dimethylcyclohexylamine, tetra-methylethylenediamine, 1-methyl-4-dimethylaminoethyl-piperazine, 3-methoxy-N-dimethyl-propylamine, N-ethylmorpholine, diethylethanol-amine, N-cocomorpholine, N,N-dimethyl-N′,N′-dimethylisopropyl-propylene diamine, N,N-diethyl-3-diethyl aminopropylamine and dimethyl-benzyl amine. A catalyst for the trimerization of polyisocyanates, such as an alkali metal alkoxide or carboxylate, or certain tertiary amines, are often employed. Such catalysts are used in an amount which measurably increases the rate of reaction of the polyisocyanate. Typical amounts are 0.1 to 10.0% by weight, based on the total weight of the foam producing mixture.

The foam producing mixture is sprayed by a person or a robot, onto a surface, such as onto an exterior wall, or the inside surface of a roof, to which the foam producing mixture will adhere and the foam structure will be created and harden in place. Various spray application devices can be used to spray the foam composition onto a surface. One suitable device is a Fusion CS plural-component spray gun commercially available from Graco Inc. of Minneapolis, Minnesota. Many spray application devices include a heater to heat the foam producing mixture or its components, to make the mixture less vicious and more likely to be sprayed evenly. As noted above, polyurethane foam is formed from combining a polyol component that typically comprises one or more polyols and other additives, such as blowing agents and flame retardants, among others, and a polyisocyanate component. In these cases, it is often desirable that the polyol component and polyisocyanate component be metered and mixed in a plural-component spray gun at a 1:1 volume ratio.

The spray emitted from the spray application device is in a shape reflective of the nozzle, which is often in the shape a cone. It is referred to herein as a cone, although the shape may not be mostly circular; the cone may have an oblong or a flat shape. The spray forms a pattern as it hits and attaches to the surface to which it is applied. The person or robot that applies the spray then moves the spray application device to apply a relatively even amount of the foam onto the intended surface. The speed and movement of the person or robot applying the foam, as well as the locations that are sprayed, may depend upon the quality of the cone and spray pattern. In applying the spray, it is important to maintain uniform or minimum thickness, and monitor the quality of the foam such that it does not contain voids.

The reaction of the foam producing mixture to create the foam upon the surfaces is an exothermic one. So the foam will be at an elevated temperature after it is created, before it eventually cools down to room temperature. In addition, the blowing agent composition often acts as an insulator, so it will retain the heat of the reaction even longer after the reaction has completed. An infrared imaging device can detect these differences in temperature that are present in the foam. In addition, an optical or infrared camera can detect voids in the foam, which may show up as warmer or cooler than other areas of the foam. Additionally, the IR and optical camera can be used for quality control to ensure that all of the areas that should have been sprayed have been sprayed, and with the intended amount of foam. Areas with a thicker amount of foam may be revealed by an IR camera as a hotter area, and cooler areas may indicate areas with insufficient foam, which can likewise be observed by an IR camera. An IR camera can also detect areas that have a sufficient amount of foam, to prevent too much foam from being applied, which would otherwise waste raw materials and make the foam application process more costly that necessary. Finally, the images can be stored as part of the quality control process demonstrating the spray foam was applied in the correct areas, quality and thicknesses, according to specifications.

Another defect that IR and optical cameras may be able to detect, include differences in foam density. As noted above, IR cameras can detect the presence of voids. IR cameras may likewise be used to detect changes in the foam which may appear as different temperatures, reflecting a different foam density. A warmer foam may be caused by the presence of more blowing agent and less foam producing mixture, which also would be a lower foam density. Conversely, a cooler temperature may indicate less blowing agent, and a higher foam density.

The heat profile that is observed by the IR camera while the spray foam is being applied, may be used to detect which defects may be occurring. It may observe areas that need to be sprayed more, or it may be used to determine that the spray is not causing the predicted amount of insulation to be applied to the surface, which be result from defects related to the quality of the mixture, the heater of the spray application device, amount of blowing agent, or issues with the spray application device itself. Conversely, an IR camera may discover that a surface to be applied already has sufficient foam on it, preventing the application of too much foam, or wasting the foam in areas where it is not needed.

The optical and/or IR camera may be placed at one or more locations where the spray from the spray application device, and the surfaces to be applied, may be observed. The camera(s) may be placed on a person or robot that is applying the spray foam, or on the spray application device. In an embodiment, there may also be a projection device that projects a visual indication of where additional spray foam is needed to be applied to a surface to meet quality standards, such as a laser pointer or other projection device that illuminates upon a surface to indicate an area does not have sufficient spray foam applied to it. The projection device may also project a visual indication of when too much foam has been applied, to assist a person applying the spray foam. The projection device may be in the form of a heads up display that is shown relative to the operator of the spray foam application device. The projection device may also be in the form of virtual or augmented reality, where the operator of the spray foam application device wears a pair of goggles, and experiences a view of the area to be sprayed, along with what appears to the operator as a projection in the room. The projection may appear as different colors that change as foam is applied, to indicate the amount relative to the specification that has been applied. For example, the color may be red if it has not been sprayed, the color may turn to yellow as it is close to being sprayed sufficiently, then green as sufficient foam has been applied, and then blue as too much foam has been applied.

Likewise, in another embodiment there is a device that may provide an auditory indication of where additional spray foam is needed to be applied to meet quality standards, or when too much foam has been applied. Such an auditory indication may be an alarm, or a computer-simulated voice that may be emitted from a speaker, or to a headset or earpiece, to provide feedback such as, too much foam has been applied or more foam is needed.

In an embodiment with a robot, a spray application device may be added to the robot, or even combined with the robot. A signal may then be transmitted to the robot or to the spray application device to apply spray foam to a particular area, such as an area identified by the IR or optical camera. The signal may also be to modify a process parameter that is used in producing or applying spray foam.

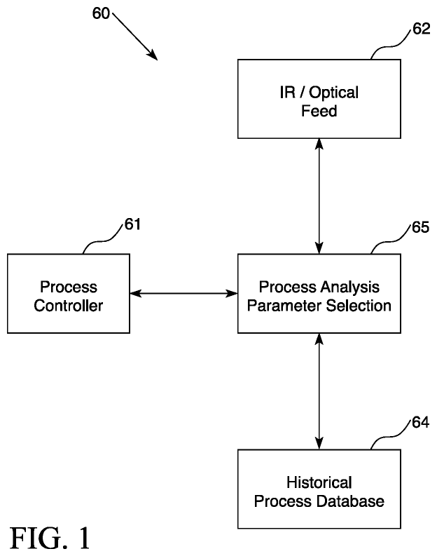

Referring to FIG. 1, a system 60 for analyzing and controlling a process to spray and apply foam is shown. The system 60 may include a process controller 61 in communication with a process analysis and parameter selection system 65 in order to provide the process controller with instructions to spray foam, or to stop spraying foam, along with the process parameters used to mix and/or heat the foam components. The process parameters may include the pressure, flow or relative flow of the components of the foam producing mixture through the spray application device, the speed or direction of the spray, and the spray pattern. In other embodiments, the process parameters may also include areas to spray foam, or to re-spray foam. The process controller 61 may be a computing device and may include a screen to display on at least one user interface for the user to interact with the process analysis and parameter selection system 65 to view a visible representation of the IR and/or optical IR feeds 62 and/or the process parameters, and control the process for mixing and/or applying the spray foam.

The system 60 preferably comprises infrared (IR) and/or optical feed 62, wherein an infrared camera and/or an optical camera and/or other infrared or optical imaging device send(s) pictures or video of the spray foam producing and application process to the process analysis and parameter selection system 65. Process analysis and parameter selection system 65 comprises data to determine if the images in IR/optical feed show the cone and applied spray foam in normal operation, or if it shows an image of an applied area that is off-spec, or the image of a cone that indicates it will likely apply as off-spec material. Alternatively, such data may be stored or learned, in historical process database 64 as discussed below.

The still or video images provided to process analysis and parameter selection system 65 allow it to determine if there is a problem in the production or application process, such as not enough spray foam upon a surface, the cone or spray pattern changing, the quality of the mixture, the heat of the mixture being sprayed, the amount of blowing agent, as well as any voids that may be seen, and changes in the sizes of voids. As noted above, another defect that may be identified as requiring correction is foam density. This allows process analysis and parameter selection system 65 to take early action to fix the problem, either before the quality of the spray foam has deteriorated, or at least to minimize the downtime and waste associated with off-spec foam being applied. Examples of actions it can take include notifying a process operator, either directly or through process controller 61, and/or by sending alternate process parameters to process controller 61. Examples of alternate process parameters include altering the relative flow of the components of the mixture, such that the components are added in different amounts or pressures, or different components are included in the mixture, increasing or decreasing the heat applied to the mixture, adjusting the spray application device such as changing a nozzle setting, or stopping the spray foam application. Such corrective actions may allow for the spray foam to be produced and applied in a high quality manner, and the issue may be corrected at a later time after the intended surfaces are applied with spray foam.

To determine how to alter process parameters in case of changes as seen from the optical and/or IR feeds, process analysis and parameter selection system 65 may communicate with historical process database 64, which may have stored or learned solutions. The solutions comprise data associated with correcting defects identified by IR/optical feed 62, such as insufficient thickness, mixture or heating quality, the formation of voids, or changes in foam density. Solutions may be learned by artificial intelligence or machine learning, to provide process parameters that may be used to correct for defects that may be seen or predicted by process analysis and parameter selection system 65 and IR/optical feed 62.

The historical process database 64 may include process parameter data associated with previous spray foam mixtures and applications, including the IR/optical feeds for particular mixtures and how they may have changed as a result of the process parameter changes. In this way, process analysis and parameter selection system 65 may analyze and consider IR or optical images of cones, spray patterns and sprayed foam on surfaces for similar mixtures, and past actions to correct problems, to create the process parameters to correct the present problem. Historical process database 64 may be loaded with such data and information, and may also learn such data and information as the process experiences problems identified by process analysis and parameter selection system 65 and IR/optical feed 62.

The process analysis and parameter selection system 65 may comprise a predictive model associated with process parameter data along with IR and/or optical images to produce and apply spray foam mixtures, from historical process database 64. The predictive models may be generated using interpolations of existing data, database lookups of matches, multiple regression models of effects on altering process parameters in properties of sprayed foam, including images taken after making such process alterations, or any number of machine learning and neural network algorithms. The predictive model generator may generate methods of correcting problems identified using images from the IR/optical feed, and associated process parameters.

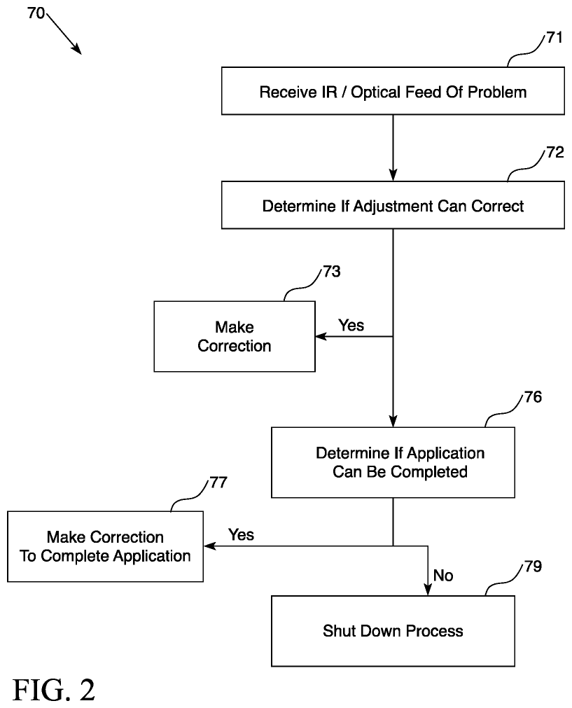

Referring to FIG. 2, a method 70 for rectifying a problem in the production and application of spray foam is shown. In this method, the process analysis and parameter selection system receives an IR/optical feed showing there is a problem 71 in the production or application process for spray foam. The problem may be of a nature such that product defects such as voids are being produced in the foam, or that the foam has insufficient foam density or thickness, and the defect is detected by the IR/optical feed. Other defects include the cone or spray pattern is not the expected shape or pattern. Another possible defect is the spray temperature is insufficient, i.e., it is not hot enough or is too hot, as detected by the IR camera. The process analysis and parameter selection system may also consider a trend showing a change in the images, which would indicate a problem will likely occur in the future, or is in the process of being applied to a surface.

The system then makes a determination 72 if an adjustment can correct the problem. To make this determination, the system may consider its historical process database. From data in the system and/or in the historical process database, the system may consider previous or pre-loaded process changes and the resulting images from changes made to process parameters that were implemented to the system, or were pre-loaded to the system. Such changes may include altering the relative amounts of components of the foam producing mixture, to compensate for one component not flowing as planned. Another such change may be increasing the amount of heating to a mixture or its components. If a change can be made, then the system directs the process controller to make a correction 73.

If there is no such opportunity to make such an adjustment, then the system determines if the spray foam application may be completed before correcting the problem. Examples of changes that may be made to complete the application include changing the amount of time needed to apply foam on an intended surface, changing the position, orientation or angle of the spray application device. In making this determination, the system may consider the effect upon foam density and thickness, and predict if this correction would result in an applied spray foam that is within specifications. If the correction can be made, the system then proceeds to make the correction 77. If the application cannot be completed within specifications, then the system shuts the process down, and alerts the operator if applicable.

In a further non-limiting embodiment, a computer program product for creating process parameters for producing and applying spray foam includes at least one non-transitory computer readable medium including program instructions that, when executed by at least one processor, cause the at least one processor to execute any of the systems and methods described herein. The at least one processor may include the process analysis and parameter selection system 65 and/or the historical process database 64.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserve the right to amend the claims during prosecution to add features as variously described in this specification, and such amendments comply with the requirements of 35 U.S.C. § 112, first paragraph, and 35 U.S.C. § 132(a).

In addition, the following aspects are disclosed:
1. A method, system or computer program product for producing and applying spray foam, comprising:
   preparing a foam producing mixture comprising components: an organic isocyanate, a polymeric polyol and a blowing agent;
   spraying the foam producing mixture from a spray application device onto a surface, forming a cone in the space between the spray application device and the surface, and applying the foam producing mixture onto the surface;
   imaging at least one of the cone, or the applied surface, using an infrared or an optical imaging device, to capture an image of the cone or the applied surface;
   receiving a first signal comprising the captured image from the imaging device to a computing device;
   determining, based on the captured image, if a defect that requires correction exists in the cone or in the applied surface; and
   optionally, in response to determining that a defect requiring correction exists, modifying a process parameter in producing or applying spray foam.
2. The method, system or computer program product of 1 comprising the step of: in response to determining that a defect requiring correction exists, modifying a process parameter in producing or applying spray foam.
3. The method, system or computer program product of 1 or 2, wherein the infrared or optical imaging device is an infrared camera.
4. The method, system or computer program product of any of the above, wherein the defect is selected from the group consisting of voids are being produced in the foam, the foam has insufficient density, the foam has insufficient thickness, the cone or spray pattern is not the expected shape or pattern, the surface to be applied already has sufficient foam covering and the spray temperature is insufficient.
5. The method, system or computer program product of any of the above, wherein the process parameter is selected from the group consisting of altering the relative flow of a component of the mixture, altering the relative pressure of a component of the mixture, or include a different component into the mixture, increasing or decreasing the heat applied to the mixture, adjusting a setting on the spray application device, stopping the spray foam application, or designating areas to spray foam or to re-spray foam.
6. The method, system or computer program product of any of the above, further comprising:
   determining the applied spray foam does not meet quality standards, based on the captured image of the apply foam;
   determining that adding additional spray foam will satisfy quality standards; and
   applying additional spray foam to meet quality standards.
7. The method, system or computer program product of any of the above, further comprising projecting a visual indication of where additional spray foam is needed to be applied to meet quality standards, or when too much foam has been applied.
8. The method, system or computer program product of claim any of the above, wherein the projecting a visual indication is by one of a laser, a light projector, a heads up display, or by visual or augmented reality.
9. The method, system or computer program product of any of the above, further comprising providing auditory indication of where additional spray foam is needed to be applied to meet quality standards, or when too much foam has been applied.
10. The method, system or computer program product of any of the above, wherein the providing auditory indication is by one of a speaker, a headset, or an earbud.
11. The method, system or computer program product of any of the above, further comprising:
   displaying on a user interface at least one of a process parameter and a visual representation of the captured image;
   receiving on the user interface an input to change at least one process parameter; and
   altering the at least one process parameter in response to the input from the user interface.
12. The method, system or computer program product of any of the above, wherein in response to determining that a defect requiring correction has appeared, modifying a process parameter in producing or applying the spray foam, comprises:
   receiving, with at least one processor, at least one of: (a) data associated with a previously-stored solution to correcting the defect that has appeared in the cone or in the applied surface; or (b) data from a predictive model used to generate a solution to correcting the defect that has appeared in the cone or in the applied surface; and
   altering at least one process parameter in response to the data received by the at least one processor.
13. The method, system or computer program product of any of the above, further comprising:
   receiving a second signal comprising a captured image from the imaging device to a computing device, after the process parameter has been modified; and
   storing data associated with the first and second signals, and the modification of the process parameter in producing or applying spray foam, to the computing device.
14. The method, system or computer program product of any of the above, further comprising placing on a moveable robot, at least one of a spray application device, an IR camera, an optical camera, and a projection device.
15. The method, system or computer program product of any of the above, further comprising:
   placing a projection device on a moveable robot; and
   projecting, from the projection device, a visual indication of where additional spray foam is needed to be applied to meet quality standards.
16. The method, system or computer program product of any of the above, further comprising:
   placing a spray application device on a moveable robot; and
   transmitting a signal to the robot or spray application device to modify a process parameter in producing or applying spray foam.

1. A method for producing and applying spray foam, comprising:
preparing a foam producing mixture comprising components: an organic isocyanate, a polymeric polyol and a blowing agent;
spraying the foam producing mixture from a spray application device onto a surface, forming a cone in the space between the spray application device and the surface, and applying the foam producing mixture onto the surface;
imaging at least one of the cone, or the applied surface, using an infrared or an optical imaging device, to capture an image of the cone or the applied surface;
receiving a first signal comprising the captured image from the imaging device to a computing device;
determining, based on the captured image, if a defect that requires correction exists in the cone or in the applied surface; and
optionally, in response to determining that a defect requiring correction exists, modifying a process parameter in producing or applying spray foam.

2.-4. (canceled)

5. The method of claim 1, further comprising the steps of:
determining the applied spray foam does not meet quality standards, based on the captured image of the apply foam;
determining that adding additional spray foam will satisfy quality standards; and
applying additional spray foam to meet quality standards.

6.-9. (canceled)

10. The method of claim 1, further comprising the steps of:
displaying on a user interface at least one of a process parameter and a visual representation of the captured image;
receiving on the user interface an input to change at least one process parameter; and
altering the at least one process parameter in response to the input from the user interface.

11. The method of claim 1, wherein in response to determining that a defect requiring correction has appeared, modifying a process parameter in producing or applying the spray foam, comprises:
receiving, with at least one processor, at least one of: (a) data associated with a previously-stored solution to correcting the defect that has appeared in the cone or in the applied surface; or (b) data from a predictive model used to generate a solution to correcting the defect that has appeared in the cone or in the applied surface; and
altering at least one process parameter in response to the data received by the at least one processor.

12. The method of claim 1, further comprising the steps of:
receiving a second signal comprising a captured image from the imaging device to a computing device, after the process parameter has been modified; and
storing data associated with the first and second signals, and the modification of the process parameter in producing or applying spray foam, to the computing device.

13.-15. (canceled)

16. A system for producing and applying spray foam, comprising:
preparing a foam producing mixture comprising components: an organic isocyanate, a polymeric polyol and a blowing agent;
spraying the foam producing mixture from a spray application device onto a surface, forming a cone in the space between the spray application device and the surface, and applying the foam producing mixture onto the surface;
imaging at least one of the cone, or the applied surface, using an infrared or an optical imaging device, to capture an image of the cone or the applied surface;
receiving a first signal comprising the captured image from the imaging device to a computing device;
determining, based on the captured image, if a defect that requires correction exists in the cone or in the applied surface; and
optionally, in response to determining that a defect requiring correction exists, modifying a process parameter in producing or applying spray foam.

17. The system of claim 16, wherein the infrared or optical imaging device is an infrared camera.

18. The system of claim 16, wherein the defect is selected from the group consisting of voids are being produced in the foam, the foam has insufficient density, the foam has insufficient thickness, the cone or spray pattern is not the expected shape or pattern, the surface to be applied already has sufficient foam covering and the spray temperature is insufficient.

19. The system of claim 16, wherein the process parameter is selected from the group consisting of altering the relative flow of a component of the mixture, altering the relative pressure of a component of the mixture, or include a different component into the mixture, increasing or decreasing the heat applied to the mixture, adjusting a setting on the spray application device, stopping the spray foam application, or designating areas to spray foam or to re-spray foam.

20. The system of claim 16, further comprising:
determining the applied spray foam does not meet quality standards, based on the captured image of the apply foam;
determining that adding additional spray foam will satisfy quality standards; and
applying additional spray foam to meet quality standards.

21. The system of claim 20, further comprising projecting a visual indication of where additional spray foam is needed to be applied to meet quality standards, or when too much foam has been applied.

22. The system of claim 21, wherein the projecting a visual indication is by one of a laser, a light projector, a heads up display, or by visual or augmented reality.

23. The system of claim 20, further comprising providing auditory indication of where additional spray foam is needed to be applied to meet quality standards, or when too much foam has been applied.

24. The system of claim 23, wherein the providing auditory indication is by one of a speaker, a headset, or an earbud.

25. The system of claim 16, further comprising:
displaying on a user interface at least one of a process parameter and a visual representation of the captured image;
receiving on the user interface an input to change at least one process parameter; and
altering the at least one process parameter in response to the input from the user interface.

26. The system of claim 16, wherein in response to determining that a defect requiring correction has appeared, modifying a process parameter in producing or applying the spray foam, comprises:
receiving, with at least one processor, at least one of: (a) data associated with a previously-stored solution to correcting the defect that has appeared in the cone or in the applied surface; or (b) data from a predictive model used to generate a solution to correcting the defect that has appeared in the cone or in the applied surface; and
altering at least one process parameter in response to the data received by the at least one processor.

27. The system of claim 16, further comprising:
receiving a second signal comprising a captured image from the imaging device to a computing device, after the process parameter has been modified; and
storing data associated with the first and second signals, and the modification of the process parameter in producing or applying spray foam, to the computing device.

28. The system of claim 16, further comprising placing on a moveable robot, at least one of a spray application device, an IR camera, an optical camera, and a projection device.

29. The system of claim 16, further comprising:
placing a projection device on a moveable robot; and
projecting, from the projection device, a visual indication of where additional spray foam is needed to be applied to meet quality standards.

30. The system of claim 16, further comprising:
placing a spray application device on a moveable robot; and
transmitting a signal to the robot or spray application device to modify a process parameter in producing or applying spray foam.

31.-45. (canceled)
